(19) United States
(12) Patent Application Publication
(10) Pub. No.: US 2017/0365230 A1
(43) Pub. Date: Dec. 21, 2017

(54) Display devices showing multimedia in multiple resolutions with eye tracking

(71) Applicant: Darwin Hu, San Jose, CA (US)

(72) Inventor: Darwin Hu, San Jose, CA (US)

(21) Appl. No.: 15/695,008

(22) Filed: Sep. 5, 2017

(51) Int. Cl. G09G 5/00; G06F 3/01; H04N 7/01

(52) U.S. Cl. CPC G09G 5/003; H04N 7/0117; G09G 2354/00; G06F 3/013; G09G 2310/04; G09G 2340/0407

(57) ABSTRACT

Techniques for displaying a multimedia in at least two resolutions are discussed. Depending on implementation, a resolution can be a spatial resolution, an intensity level resolution, or both. A display device is designed to ensure better resolution in an area (region of focus or ROF) being focused by eyes of a viewer while relatively poor resolution in the area surrounding the ROF. The ROF moves accordingly with the motion of the pupil. As a result, the perceived resolution by the user remains high while the memory requirement for displaying such media is significantly reduced.

### BACKGROUND OF THE INVENTION

### Field of the Invention

The present invention generally relates to the area of display devices and more particularly relates to architecture and designs of display devices showing images/videos in multiple resolutions.

### Description of the Related Art

In a computing world, a display usually means two different things, a showing device or a presentation. A showing device or a display device is an output mechanism that shows text and often graphic images to users while the outcome from such a display device is a display. The meaning of a display is well understood to those skilled in the art given a context. Depending on application, a display can be realized on a display device using a cathode ray tube (CRT), liquid crystal display (LCD), light-emitting diode, gas plasma, or other image projection technology (e.g., front or back projection, and holography).

Depending on the resolution an image is to be displayed and the way the image is displayed, memories (e.g., RAM) are always needed. In general, the higher the resolution is, the more capacity the memories have to be. FIG. 1 shows an exemplary configuration 100 of displaying a video source 102 (e.g., MPEG video or an image). The configuration 100 includes a processing unit 104, a memory device 106 and a display device 108. The capacity of the memory device 106 depends on the spatial resolution of the video source (e.g., VGA or HD). In general, the higher the spatial resolution of the video source 102, the higher capacity the memory device 106 has.

With the increased demand for higher resolutions, such as 720p, 1080p, 1440p, 4K or even 8K, the capacity for the memories is getting larger and larger, resulting in higher cost in designs, materials and manufacturing. With the display applications moving to various wearing devices, more memories mean weight increasing besides inherent cost. For AR and VR applications, any increase in weight could mean a lot in adoptions by the consumers. Thus, there is a need for display techniques of showing images/videos in high resolution while not increasing the need for more memories so as to reduce the weight, design complexities and costs.

### SUMMARY OF THE INVENTION

This section is for the purpose of summarizing some aspects of the present invention and to briefly introduce some preferred embodiments. Simplifications or omissions in this section as well as in the abstract and the title may be made to avoid obscuring the purpose of this section, the abstract and the title. Such simplifications or omissions are not intended to limit the scope of the present invention.

The present invention is generally related to architecture and designs of display devices, where the display devices are designed to ensure high resolution in an area (region of focus or ROF) being focused by eyes of a viewer while relatively low resolution in the area surrounding the ROF. As a result, the perceived resolution by the user remains the high resolution while the memory requirement is significantly reduced.

According to one aspect of the present invention, a pupil detector is provided to track the movement of an eye. The movement is used to define the ROF that in turn defines a sampling signal being applied to an input source. As the pupil moves across a display screen, the pupil is being tracked in real time, the ROF moves accordingly to ensure that the eye always sees the display falling in the ROF in high resolution.

According to another aspect of the present invention, the intensity level resolution in a ROF is higher than that in the surrounding area of the ROF. In a similar way, a pupil detector is provided to track the movement of an eye. The movement is used to define the ROF that in turn defines a sampling signal being applied to an input source. As the pupil moves across a display screen, the pupil is being tracked in real time, the ROF moves accordingly to ensure that the eye always sees the display falling in the ROF in more detailed intensity levels than that in the surrounding area. As a result, the perceived intensity levels by the user are more detailed while the memory requirement is significantly reduced.

The present invention may be implemented as an apparatus, a method, a part of system. Different implementations may yield different benefits, objects and advantages. According to one embodiment, the present invention is a display system comprising: a display screen; a pupil detector, disposed near the display screen, provided to track motion of an eye looking at the display screen; an area calculator, coupled to the pupil detector, determining a region of focus (ROF) on the display screen for the eye in accordance with an output from the pupil detector, wherein the ROF is where the eye is looking at on the display screen; and a sampling circuit generating a sampling signal in at least two different rates, first and second sampling rates, wherein the first sampling rate is applied when data from a media to be displayed in the ROF, and the second sampling rate is applied when data from the media to be displayed in an area other than the ROF.

According to another embodiment, the present invention is a display method comprising: tracking by a pupil detector motion of an eye looking at a display screen; determining a region of focus (ROF) on the display screen for the eye in accordance with an output from the pupil detector, wherein the ROF is where the eye is looking at on the display screen; and generating a sampling signal in at least two different rates, first and second sampling rates, wherein the first sampling rate is applied when data from a media to be displayed in the ROF, and the second sampling rate is applied when data from the media to be displayed in an area other than the ROF.

One of the objects in the present invention is to reduce the requirement for memory capacity while maintaining to display the same or better perceived image quality.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows an exemplary configuration of displaying a video source (e.g., MPEG video or an image);

FIG. 2A shows an exemplary configuration according to one embodiment of the present invention;

FIG. 2B shows that a display screen is being looked at by an eye;

FIG. 2C illustrates an example in which a display device includes a display screen integrated with two pupil detectors, each of which is disposed near the display screen to track the motion of a pupil in an eye so as to determine a region of focus that is being focused on by the eyes;

FIG. 2D shows a pair of glasses specifically designed for AR or VR applications;

FIG. 2E shows an example of integrated parts that may be used in the glasses of FIG. 2D;

FIG. 2F shows an exemplary sampling signal that is caused to double its sampling rate when it comes to sample the input data for a ROF;

FIG. 2G shows some examples of increasing the resolution for an ROF with respect to that in a surrounding area by 2, 3, 4 and 5 times;

FIG. 3 shows a process or flowchart of providing a display in multiple resolution; and

FIG. 4 illustrates one embodiment of keeping the same intensity and same spatial resolutions in a ROF while reducing the same for the surrounding area of the ROF.

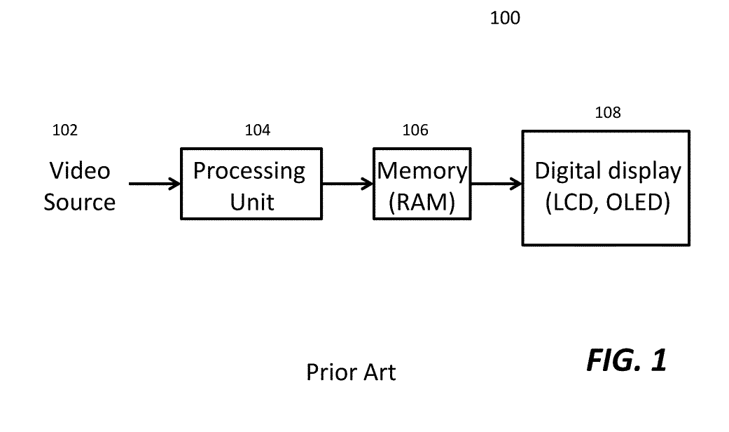

### DETAILED DESCRIPTION OF THE PREFERRED EMBODIMENTS

The detailed description of the invention is presented largely in terms of procedures, steps, logic blocks, processing, and other symbolic representations that directly or indirectly resemble the operations of data processing devices that may or may not be coupled to a network. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

As used herein, the term “video” or “video source” is used for illustrative purposes only. The term may mean any type of media content item, such as audio, images, digital movies, digital photos, digital music, website content, social media updates, electronic books (ebooks), electronic magazines, digital newspapers, digital audio books, electronic journals, electronic comic books, software applications, or other media content.

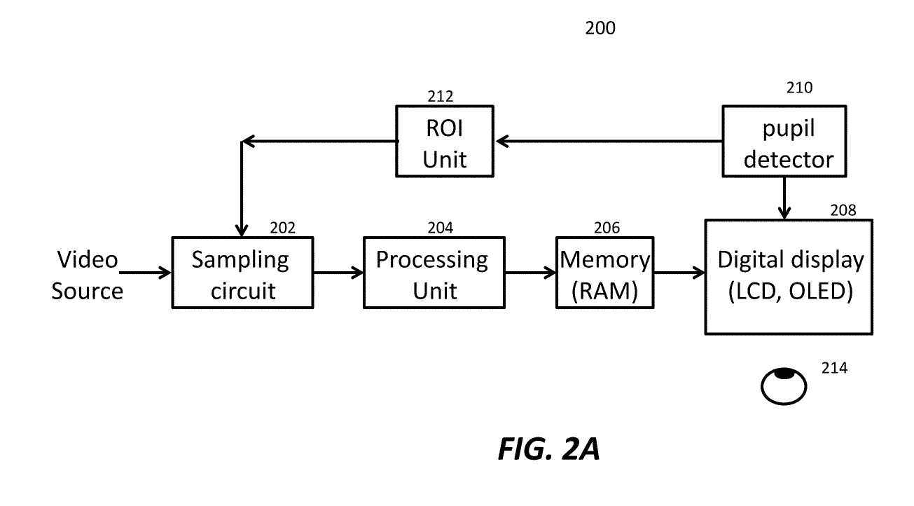

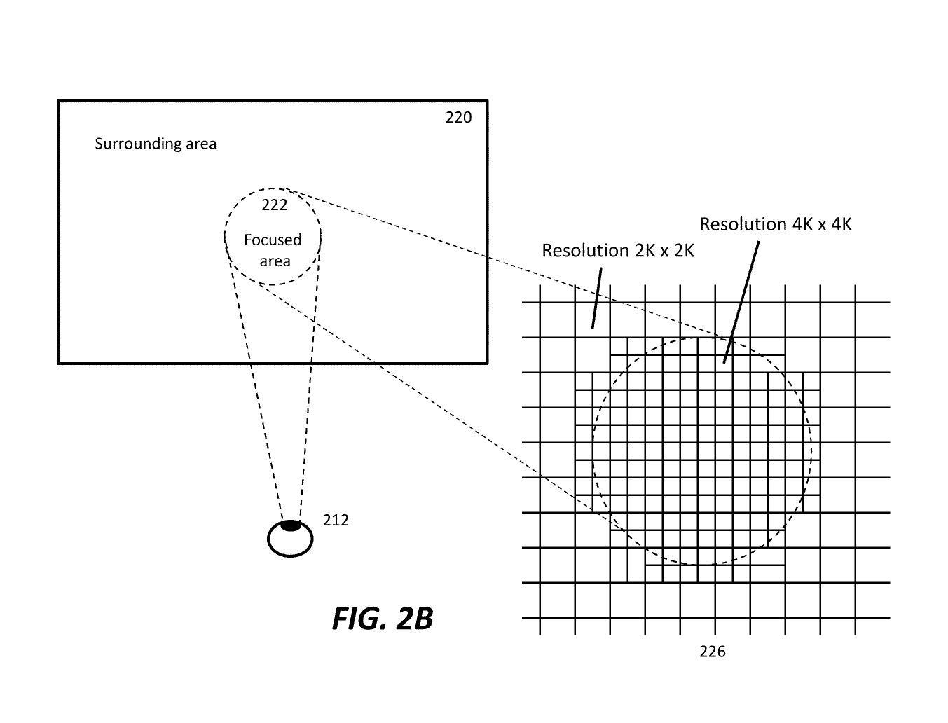

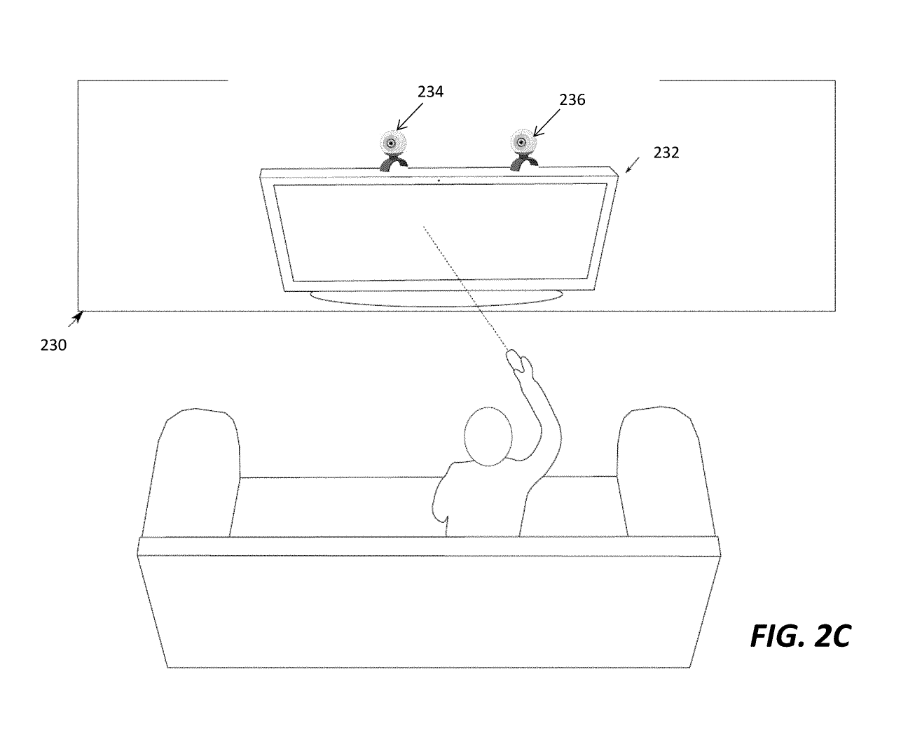

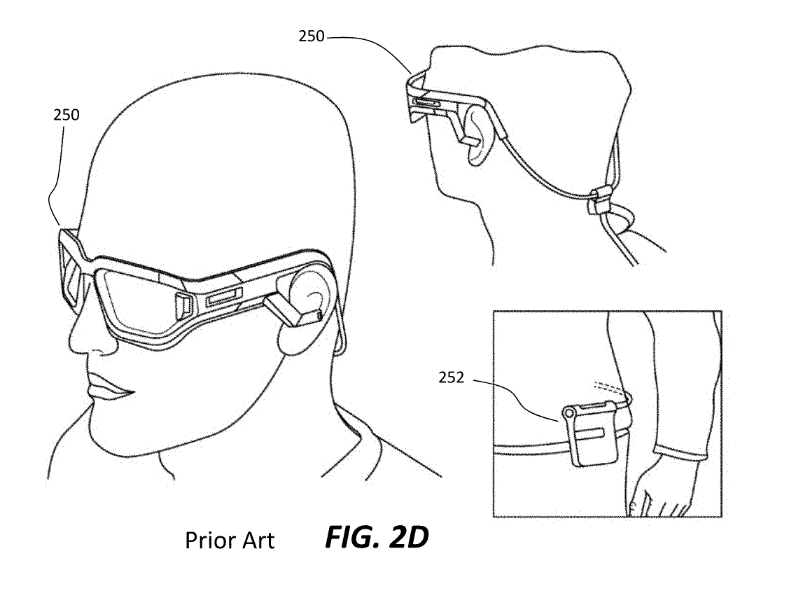

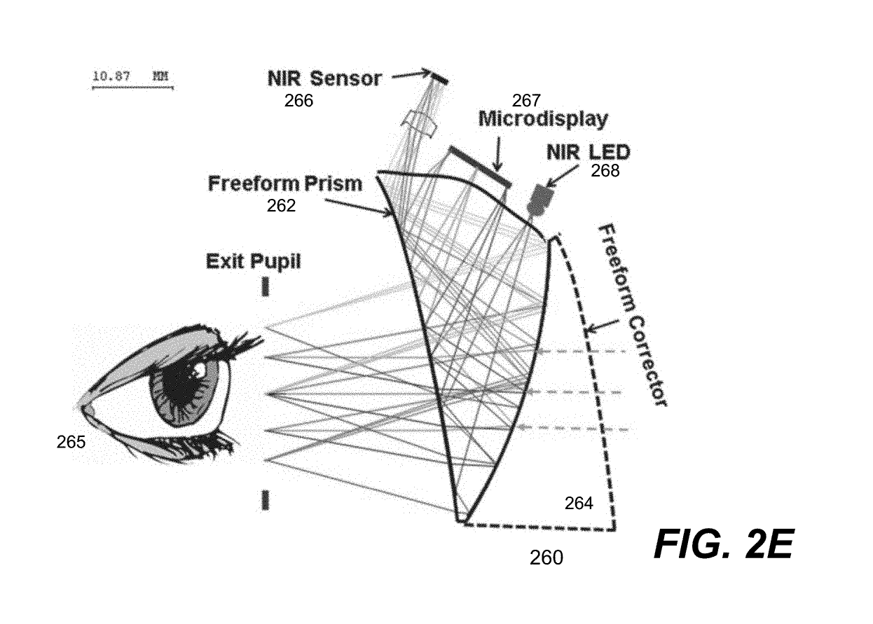

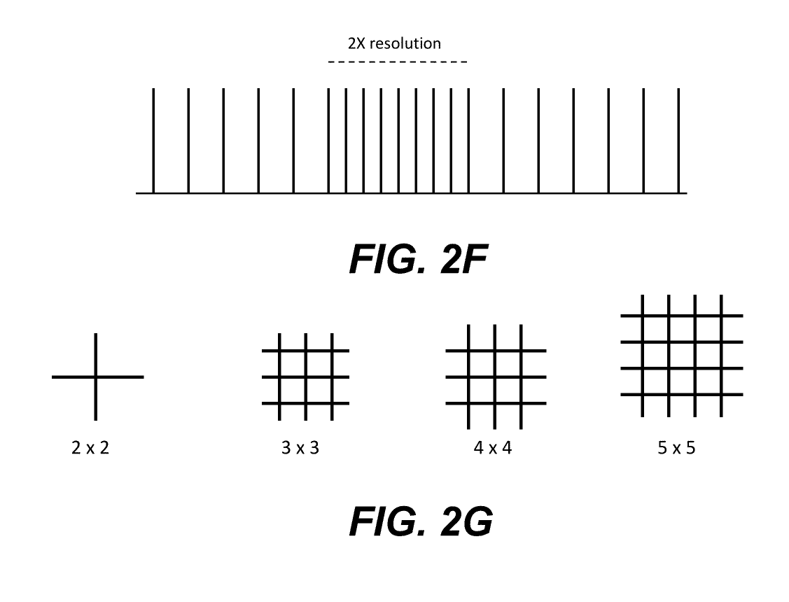

Referring now to the drawings, in which like numerals refer to like parts throughout the several views. FIG. 2A shows an exemplary configuration 200 according to one embodiment of the present invention. The configuration 200 includes a sampling unit 202, a processing unit 204, a memory device 206, a display device 208, a pupil detector 210 and a ROF calculation unit 212. The sampling unit 202 is provided to sample the video source at a standard and/or a rate subject to one or more inputs from pupil detector 210. The processing unit 204 is provided to receive the sampled input, typically in two or more spatial resolutions, and process the data before they are transported to the memory device 206 for display on the display device 208. According to one embodiment, the display device 208 is a digital display that is essentially a flat panel screen that relies on different technologies to present multimedia content to an audience. The most common flat panel screens are LCD screens which use liquid crystal cells to display content, LED screens that are based on Light Emitting Diode technology and OLED screens that are based on a flat light emitting technology by placing a series of organic thin films between two conductors. Digital displays on their own cannot do much. They need some type of media player hardware and software that can render appropriate content for them.

According to one embodiment of the invention, a pupil detector is positioned near a display screen and focuses at an eye to track the movement of the pupil in the eye. A pupil detector is a dedicated tracking device often used in a head-mounted eye tracking device for applications on top, such as gaze-based human-computer interaction or attention analysis. No further details on how a pupil detector works is described herein to avoid obscuring aspects of the present invention. There are many discussions available (e.g., A. P\check{a}sáric\check{a}, Pupil detection algorithms for eye tracking applications, 2015 IEEE 21st International Symposium for Design and Technology in Electronic Packaging, 22-25 Oct. 2015). In summary, the pupil detector 210 provides data or information as to where the eye is looking at on a display screen.

FIG. 2B shows that a display screen 220 is being looked at by an eye 214. An area 222 being focused by the eye 214, referred to herein as a focused area or a region of focus (ROF), is shown in a circle on the display screen 220. In other words, the eye 214 focuses at the ROF 222 and does not really pay attention to the area surrounding the ROF. What FIG. 2B shows is that no matter how large a display screen is, a viewer can only focus on a limited area on the display. Although people in general do seek a large screen, their eyes are constantly moving across the large screen to focus on an ROF. The rest of the display screen 220, referred to herein as surrounding display area or simply surrounding area, is there for the eye to move onto any time. As the eye 214 is moving across the display screen 220, the ROF 222 is always there and moving accordingly. To determine the exact location of the ROF 222, the pupil detector 210 is used to track the movement of the pupil. According to one embodiment, the ROF 222 can be fairly well defined in accordance with the tracking activities of the pupil detector 210.

From the vision perspective, the shape of the ROF 222 is of round. Those skilled in the art shall appreciate that there is no inherent limitations as to the shape of the ROF 222, it can be of any shape if needed. Similarly, the sizes or a diameter of the ROF 222, subject to the vision of a viewer, may be adaptively adjusted according to the vision of the eye 214 or mathematically pre-determined. Some people may have a wider ROF and some may have an irregular shape of a ROF. In any case, the differences can be minimized when the area of the ROF 222 is adjusted large enough to avoid a viewer to notice the surrounding are when focusing on the ROF, but certainly not more than the necessary.

According to one embodiment, the display resolution in the ROF 222 is higher than that in surrounding display area. In other words, the display 220 displays a video in at two different resolutions, a high resolution in the ROF 222 and a low resolution in the surrounding area, as shown in the expanded portion 226. As an example, a video source is in the resolution of 4K×4K. Instead of displaying an entire image from the video source in 4K×4K on a display screen, an image can be displayed at 2K×2K, except for the ROF 222 in which a portion of the image is displayed at 4K×4K. As long as the ROF 222 goes with the movement of the pupil, the viewer would not visually notice the differences in display resolutions. One of the important features, benefits and advantages in the present invention is the significant saving in the memory that is needed to display the video without affecting the perceived displayed quality of the video.

According to another embodiment, the resolutions change from a ROF and the surrounding area may be made gradually. For example, an input video is received in a resolution of 6K×6K. The default display resolution (for the surrounding area) is set at 2K×2K while the resolution for an ROF is set at 6K×6K. Between a ROF and the surrounding area, it is possible to define an intermediate display area that is set at a resolution of 3K×3K, which results in a display with three different resolutions. From a display perspective, an image is being displayed on a screen with the original resolution in a ROF, where the original resolution is gradually reduced to the lowest setting for the resolution.

FIG. 2C illustrates an example in which a display device 230 includes a display screen 232 integrated with two pupil detectors 234 and 236, each of which is disposed near the display screen 232 to track the movement of a pupil in an eye so as to determine a ROF that is being focused on by the eyes. When the image in the ROF is displayed in a first resolution (e.g., high resolution) and the image in the surrounding area is displayed in a second resolution (e.g., low resolution), the displayed resolution to the viewer is perceived as the first resolution as long as there would be not too much difference between the first and second resolutions. In general, it is not practical that the low resolution is too much off from the high resolution, otherwise the attention from the viewer would be naturally moving towards the image being displayed in the low resolution.

FIG. 2D shows a pair of glasses 250 specifically designed for AR or VR applications. The glasses 250 include two display screens right before the eyes. To reduce the weight of the glasses 250, most of the electronic components are enclosed in a portable device 252 that is attached to the user. In operation, a video source, for example, obtained from the Internet is received in the device 252 that causes the glasses 250 to display the video. FIG. 2E shows an example of integrated parts that may be used in the glasses 250. One of the integrated parts is the lens 260.

The lens 260 includes two parts, a prism 262 and an optical correcting lens or corrector 264. The prism 262 and the corrector 264 are stacked to form the lens 260. As the name suggests, the optical corrector 264 is provided to correct the optical path from the prism 262 so that a light going through the prism 262 goes straight through the corrector 264. In other words, the refracted light from the prism 262 is corrected or de-refracted by the corrector 264. In optics, a prism is a transparent optical element with flat, polished surfaces that refract light. At least two of the flat surfaces must have an angle between them. The exact angles between the surfaces depend on the application. The traditional geometrical shape is that of a triangular prism with a triangular base and rectangular sides, and in colloquial use a prism usually refers to this type. Prisms can be made from any material that is transparent to the wavelengths for which they are designed. Typical materials include glass, plastic and fluorite. According to one embodiment, the type of the prism 262 is not in fact in the shape of geometric prisms, hence the prism 262 is referred herein as a freeform prism, which leads the corrector 264 to a form complementary, reciprocal or conjugate to that of the prism 262 to form the lens 260.

A sensor 266 is provided to image the position or movement of the pupil in the eye 265. Again, based on the refractions provided by the prism 262, the location of the pupil can be seen by the sensor 266. In operation, an image of the eye 265 is captured. The image is analyzed to derive how the pupil is looking at the image being shown through or in the lens 260. In the application of AR, the location of the pupil may be used to activate an action. Optionally, a light source 268 is provided to illuminate the eye 265 to facilitate the image capture by the sensor 266. According to one embodiment, the light source 268 uses a near inferred source as such the user or his eye 265 would not be affected by the light source 268 when it is on.

In the application of FIG. 2D or FIG. 2E, when an embodiment of the present invention is employed, there is no need to display a video all in high resolution across the display screen, only the video falling in the ROF is in high resolution and a viewer perceives the displayed video in high resolution. As a result, there is a significant saving in the memory devices and other associated components, resulting in weight reductions and cost saving in the glasses 250 or the portable device 252.

Referring back to FIG. 2A, the pupil detector 210 detects the movement of the pupil and sends out the location of the pupil with respect to a reference (e.g., the screen being looked at). Upon receiving the location information, the ROF unit 212 calculates an appropriate area (e.g., a circle, an ellipse or any appropriate shape) that can then be used to determine what are the pixels that need to display an input at high or original resolution. FIG. 2F shows an exemplary sampling signal that is caused to double its sampling rate when it comes to sample the input data for the ROF. In other words, data rate for the ROF is doubled in respect to the data rate for the surrounding display area. As a result, the resolution in the ROF is twice as much as that in the surrounding area. It should be noted that the ROF is moving accordingly with the movement of the pupil so that the eye of the viewer focuses always on the higher resolution area, resulting a higher perceived resolution.

FIG. 2G shows some examples of increasing the resolution for an ROF with respect to that in a surrounding area by 2, 3, 4 and 5 times. According to one embodiment, an input video source is assumed to be in a resolution of 4K×4K. Instead of taking all the data for display, which would require a large amount of memory, the sampling circuit 202 is provided to sample the input to take the data needed for the display. Given the location of the pupil and the ROF detected, the ROF unit 212 is designed to calculate what is the sample rate needed for the surrounding area, where it is assumed that the display in the ROF keeps the same resolution as the input has. It is assumed that the resolution in the surrounding area is half of that in the ROF, thus the sampling signal as shown in FIG. 2F can be used. Should the surrounding area be desired to show lower resolution, the sampling signal can be regenerated or modified.

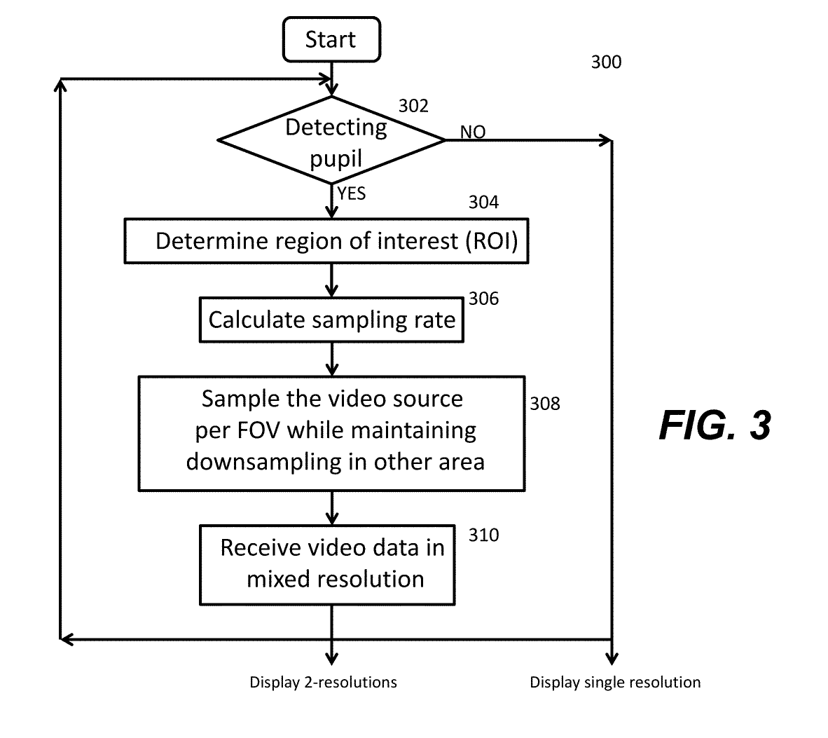

FIG. 3 shows a process or flowchart 300 of providing a display in multiple resolution. The flowchart 300 may be implemented in software or a combination of software and hardware. According to one embodiment, the flowchart 300 may be implemented in conjunction with the configuration shown in FIG. 2A.

At 302, a pupil detector tracks the movement of a pupil. If there is no detection (e.g., no one is watching the display), the process 300 goes to the right, where the display resolution may be set to a default, for example, ½, ⅓ or ¼ of the resolution in the input video (less than the original resolution). It is now assumed that the pupil detector can detect that a viewer is looking at a display and start to track the movement of the pupil. The process 300 goes to 304 to determine where is the ROF on the display screen and set up a size for it. As previously described, the size or shape for a ROF may be determined statistically or mathematically determined. At 306, a sampling signal is determined. According to one embodiment, the sampling signal is originally generated in accordance with the resolution of the input. Now it is assumed that the surrounding area is for displaying the input at one half resolution. Thus the originally sampling signal may be decimated but kept unchanged when the signal samples are taken for displaying in the ROF. At 310, the memory device receives the data for display in two or more resolutions.

The above description is mainly focused on keeping the original spatial resolution in a ROF and reducing the spatial resolution in the surrounding area. Those skilled in the can appreciate that the above description is equally applicable when there is a need to display a media within a ROF in a resolution higher than the original resolution while keeping the original resolution or lower in the surrounding area.

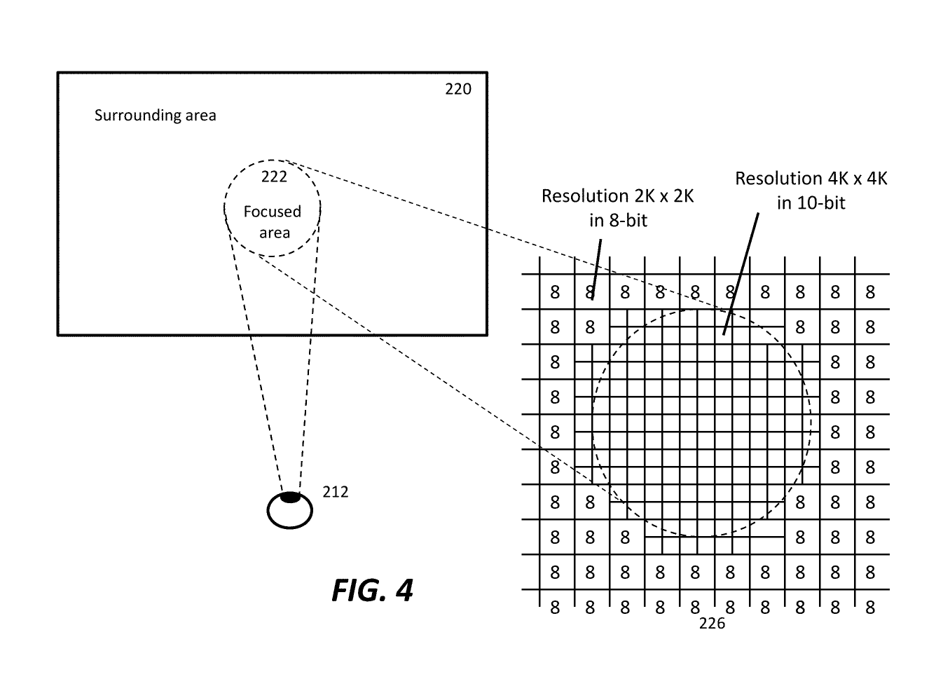

It shall be also appreciated to those skilled in the art that the above description may be equally applicable to keeping the intensity-level resolution high in a ROF while slightly lowing the intensity resolution in the surrounding area. This will also reduce the requirement for the memory capacity. For example, the input video is a 10-bit video, which means the gray-levels are 10 bits or each of Red, Green and Blue signals is in 10 bits. Instead of showing the input (multimedia) all in 10 bits across the entire screen, the 10-bit resolution is reduced to 8-bit resolution for the surrounding area while keeping the 10-bit resolution in the ROF. The perceived intensity by a viewer remains 10 bits resolution while the requirement for the memory is significantly reduced. FIG. 4 illustrates one embodiment of keeping the same intensity and same spatial resolutions in a ROF while reducing the same for the surrounding area of the ROF.

The present invention has been described in sufficient detail with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the forgoing description of embodiments.

I claim:

1. A display system comprising:
a display screen;
a pupil detector, disposed near the display screen, provided to track motion of an eye looking at the display screen;
an area calculator, coupled to the pupil detector, determining a region of focus (ROF) on the display screen for the eye in accordance with an output from the pupil detector, wherein the ROF is where the eye is looking at on the display screen; and
a sampling circuit generating a sampling signal in at least two different rates, first and second sampling rates, wherein the first sampling rate is applied when data from a media to be displayed in the ROF, and the second sampling rate is applied when data from the media to be displayed in an area other than the ROF.

2. The display system as recited in claim 1, wherein the media has a designated spatial resolution, a display of the media within the ROF is in the designated spatial resolution while a display of the media outside the ROF is in a spatial resolution lower than the designated spatial resolution.

3. The display system as recited in claim 2, further comprising:
a memory device with a predetermined capacity to receive display date sampled by the sampling circuit from the media, wherein the capacity is much less than a capacity required to display the media in the designated spatial resolution.

4. The display system as recited in claim 3, wherein the ROF is of round shape with a diameter determined statistically or pre-calculated.

5. The display system as recited in claim 3, wherein the ROF moves following the motion of the eye to ensure that the eye always focuses in the ROF.

6. The display system as recited in claim 1, wherein the media has a designated intensity resolution, a display of the media within the ROF is in the designated intensity resolution while a display of the media outside the ROF is in a density resolution lower than the designated intensity resolution.

7. The display system as recited in claim 6, further comprising:
a memory device in with a predetermined capacity to receive display date sampled by the sampling circuit from the media, wherein the capacity is much less than a capacity required to display the media in the designated intensity resolution.

8. The display system as recited in claim 1, wherein the display system is integrated in a pair of glasses, the pupil detector is disposed near one integrated lens of the glasses to track the motion of the pupil looking through the lens at a display screen.

9. The display system as recited in claim 8, wherein the media is projected onto the display screen formed optically in the glasses.

10. The display system as recited in claim 9, wherein the motion of the pupil is determined with respect to the integrated lens.

11. A display method comprising:
tracking by a pupil detector motion of an eye looking at a display screen;
determining a region of focus (ROF) on the display screen for the eye in accordance with an output from the pupil detector, wherein the ROF is where the eye is looking at on the display screen; and
generating a sampling signal in at least two different rates, first and second sampling rates, wherein the first sampling rate is applied when data from a media to be displayed in the ROF, and the second sampling rate is applied when data from the media to be displayed in an area other than the ROF.

12. The display method as recited in claim 11, wherein the media has a designated spatial resolution, a display of the media within the ROF is in the designated spatial resolution while a display of the media outside the ROF is in a spatial resolution lower than the designated spatial resolution.

13. The display method as recited in claim 12, further comprising:
a memory device with a predetermined capacity to receive display date sampled by the sampling circuit from the media, wherein the capacity is much less than a capacity required to display the media in the designated spatial resolution.

14. The display method as recited in claim 13, wherein the ROF is of round shape with a diameter determined statistically or pre-calculated.

15. The display method as recited in claim 13, wherein the ROF moves following the motion of the eye to ensure that the eye always focuses in the ROF.

16. The display method as recited in claim 11, wherein the media has a designated intensity resolution, a display of the media within the ROF is in the designated intensity resolution while a display of the media outside the ROF is in a density resolution lower than the designated intensity resolution.

17. The display method as recited in claim 16, further comprising:
receiving display date sampled by the sampling circuit from the media in a memory device with a predetermined capacity, wherein the capacity is much less than a capacity required to display the media in the designated intensity resolution.

18. The display method as recited in claim 11, wherein the display system is integrated in a pair of glasses, the pupil detector is disposed near one integrated lens of the glasses to track the motion of the pupil looking through the lens at a display screen.

19. The display method as recited in claim 18, wherein the media is projected onto the display screen formed optically in the glasses.

20. The display method as recited in claim 19, wherein the motion of the pupil is determined with respect to the integrated lens.
